(19) United States
(12) Patent Application Publication
(10) Pub. No.: US 2006/0246302 A1
(43) Pub. Date: Nov. 2, 2006

(54) Methods for protecting glass

(76) Inventors: Michael D. Brady, Painted Post, NY (US); Gordon F. Foster, Campbell, NY (US); Himanshu C. Shah, Painted Post, NY (US); David A. Tammaro, Painted Post, NY (US)

Correspondence Address: CORNING INCORPORATED, SP-TI-3-1, CORNING, NY, 14831, US

(21) Appl. No.: 11/119,511

(22) Filed: Apr. 29, 2005

(51) Int. Cl. B32B 17/10; B05D 5/12; B05D 5/06; B05D 3/02; B32B 17/06

(52) U.S. Cl. 428/441; 428/426; 427/64; 427/162; 427/372.2

(57) ABSTRACT

Described herein are methods for protecting glass.

### BACKGROUND

Many uses of glass, including LCD glass, require a very clean glass surface that is substantially free of particle and organic contaminants. When exposed to the environment, glass can quickly become contaminated with organic contaminants, with contamination being observed within a few minutes. Cleaning processes currently used for cleaning LCD glass often involve several steps and require a variety of chemicals. There is a need, therefore, for a method of protecting a glass surface from ambient contaminants during manufacture, shipping, and storage to minimize or even eliminate the need for chemicals to provide a clean glass surface.

Current procedures used to cut and grind glass surfaces and edges often generate small glass chips (e.g., chips having a size greater than 1 micron and less than about 100 microns). Some of these particles irreversibly adhere to the clean glass surface, rendering the glass useless for most applications. This is particularly a serious problem in the case of LCD glass surfaces.

LCD glass can be made by a fusion draw process, which yields flat, smooth glass surfaces, which can be cut or ground to the desired size. Some of the glass chips generated from the cutting process originate from the surface of the glass. When the flat surface of these chips comes into contact with the surface of the glass plate, there can be a large contact area between the chips and the glass surface which promotes strong adhesion. If a water film condenses between these two surfaces, permanent chemical bonding may occur, in which case the adhesion of the glass chips to the surface becomes irreversible. This may make the glass useless for LCD applications.

One known method for protecting glass sheets, specifically, sheets of LCD glass, is to apply a polymer film on both major surfaces of the glass to protect the glass during the scoring, breaking, and beveling processes. In a typical method, one major surface has a polymer film attached with an adhesive, and the other major surface has a film attached by static charge. The first film is removed after the edge finishing (cutting or grinding) of the sheet is completed, while the second is removed prior to the finishing process. Although the adhesive-backed film protects the surface from scratching by the handling equipment, it causes other problems. For example, the polymer film may entrap glass chips produced during the finishing process, leading to a build up of glass chips and scratching of the glass surface, particularly near the edges of the surface. Another problem with this film is that it may leave an adhesive residue on the glass surface. There is a need, therefore, for a method of protecting a glass surface from chip adhesions that does not leave any residual coating on the glass surface, and for a method of temporarily protecting glass surfaces, whereby a glass article with a clean, coating-free surface can be readily obtained for further use.

Removability of the coating used to temporarily protect LCD glass is another important consideration. Manufacturers of liquid crystal displays use LCD glass as the starting point for complex manufacturing processes, which typically involve forming semiconductor devices, e.g., thin film transistors, on the glass substrate. To not adversely affect such processes, any coating used to protect LCD glass must be readily removable prior to the beginning of the LCD production process.

Thus, it would be desirable to have a coating that possesses the following characteristics:

(1) the coating should be one that can be readily incorporated in the overall glass forming process, specifically, at the end of the forming process, so that newly formed glass is substantially protected immediately after it is produced; among other things, the coating should be able to withstand the environment (e.g., up to 350° C.) of a glass forming line, be environmentally safe, easy to spread across the glass surface using conventional techniques (e.g., spraying, dipping, flooding, meniscus, etc.), and water resistant;

(2) the coating should protect the glass from chip adhesion resulting from cutting and/or grinding of the glass sheet, as well as the adhesion of other contaminants, e.g., particles, that the glass may come into contact with during storage and shipment prior to use;

(3) the coating should be sufficiently robust to continue to provide protection after being exposed to substantial amounts of water during the cutting and/or grinding process;

(4) the coating should be removable, either substantially or completely, from the glass prior to its ultimate use in order to minimize the number of particles present on the glass surface by detergents or non-detergents; and

(5) the coating once applied to the glass does not stick to interleaf paper between sheets of glass once the coated glass has been stacked.

The methods described herein satisfy this long standing need in the art.

### SUMMARY

Described herein are methods for protecting glass. The advantages of the materials, methods, and articles described herein will be set forth in part in the description which follows, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF FIGURES

The accompanying Figures, which are incorporated in and constitute a part of this specification, illustrate several aspects described below.

FIG. 1 shows the thermal analysis data of a coating described herein on a glass surface.

FIG. 2 shows the nanoindentation data for a 6% coating (a thickness of 2 microns) and 12% coating (a thickness of 14 microns) on LCD glass.

### DETAILED DESCRIPTION

Before the present materials, articles, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Disclosed are compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a number of different polymers and biomolecules are disclosed and discussed, each and every combination and permutation of the polymer and biomolecule are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C—F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Described herein are methods for protecting glass. In one aspect, described herein is a method for protecting glass for a liquid crystal display, comprising (i) applying to at least one surface of the glass a coating composition, wherein the coating composition comprises:

(a) a base soluble polymer;

(b) a volatile base;

(c) a surfactant; and

(d) water,

to produce a coated glass, and (ii) drying the coated glass to remove the water and volatile base to produce a protective film on the surface of the glass.

In terms of liquid crystal display glass, particle-free sheets (substrates) are of importance since they are the starting point for determining the quality of the LCD thin film transistors formed on the sheets. As discussed above, adhesion of glass particles to substrates is a long standing problem in the manufacture of LCD glass. In particular, scoring at the bottom of draw (BOD) is a main source of adherent particles during substrate manufacturing. Ultrasonic cleaning and brush cleaning can remove some particles that have been deposited on the glass for a short time. However, cleaning processes are not effective for particles deposited on a substrate for more than a few days, especially if the storage environment is hot and humid. Additionally, glass for LCD has a very low alkali content, which if is high enough, can adversely affect the performance of thin film transistors. Thus, it is also desirable to have a coating composition that will not increase alkali content upon removal of the protective film.

Coating Compositions

The coating composition used to produce a protective film on the glass comprises (a) a base soluble polymer; (b) a volatile base; (c) a surfactant; and (d) water.

The base soluble polymer is any polymer that is partially or completely soluble in an aqueous base. In the case when the polymer is partially soluble in the aqueous base, a dispersion or colloid of the base soluble polymer can be used. The base soluble polymer can have one or more groups that react with a base through either a Lewis acid/base or Bronsted acid/base interaction. For example, the base soluble polymer can have at least one carboxylic acid group, sulfonate group, phosphonate group, phenolic group, or a combination thereof.

The base soluble polymer can be derived from polymerizable monomers that possess groups that react with bases. For example, itaconic acid, maleic acid, or fumaric acid can be used to produce a base soluble polymer. In one aspect, the base soluble polymer comprises a polymer derived from an acrylic acid monomer. The term “acrylic acid monomer” includes acrylic acid and all derivatives of acrylic acid. For example, the acrylic acid monomer can be methacrylic acid. In one aspect, the base soluble polymer can be a homopolymer or copolymer derived from an acrylic acid monomer. In the case when the base soluble polymer is a copolymer derived from an acrylic acid monomer, the polymer comprises a polymerization product between an acrylic acid monomer and an olefin. In this aspect, the acrylic acid monomer can be methacrylic acid, or a mixture thereof and the olefin can be ethylene, propylene, butylene, or a mixture thereof.

In one aspect, the base soluble polymer comprises a polyethylene acrylic acid copolymer. In one aspect, the polyethylene acrylic acid copolymer has a molecular weight of from 10,000 to 100,000, 20,000 to 50,000, 30,000 to 40,000, or 30,000 to 35,000. In another aspect, polyethylene acrylic acid copolymer has an acid number of from 100 to 200, 125 to 175, or 150 to 160. In another aspect, the polyethylene acrylic acid copolymer is CAS # 009010-77-9 manufactured by Dow and Dupont.

It is also contemplated that mixtures of base soluble polymers can be used in the coating compositions For example, MP 2960 and the MP 4983 R, manufactured by Michelman Specialty Chemistry, are completely miscible with each other and can be used in a wide range of mixtures.

The coating composition further comprises a volatile base. The term “volatile base” is defined as any compound that can behave as a Lewis base or Bronsted base and has a vapor pressure that permits partial or complete removal of the base by any volatization technique. For example, the volatile base can have a vapor pressure such that it can be removed by simple evaporation at room temperature and pressure. Alternatively, the vapor pressure can be high enough so that the base is not volatile unless exposed to elevated temperatures. In one aspect, when partial removal of the base is desired, greater than 80%, greater than 85%, greater than 90%, greater than 95%, or greater than 99% of the base can be removed. In certain aspects, it is desirable to remove enough of the volatile base so that the resultant film produced by the coating composition is not solubilized by the water.

In one aspect, the volatile bases comprises a trialkyl amine or a hydroxyalkyl amine. The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms. The term “hydroxyalkyl group” as used herein is an alkyl group as defined above where at least one of the hydrogen atoms is replaced with a OH group. Examples of volatile bases include, but are not limited to, triethylamine or triethanolamine. In another aspect, the volatile base comprises ammonia. The amount of volatile base used will vary depending upon the solubility of the base and the desired pH of the coating composition.

Surfactants useful herein can be anionic, nonionic, or cationic. In one aspect, when the surfactant is an anionic surfactant, the anionic surfactant comprises an alkyl aryl sulfonate, an alkyl sulfate, or sulfated oxyethylated alkyl phenol. Examples of anionic surfactants include, but are not limited to, sodium dodecylbenzene sulfonate, sodium decylbenzene sulfonate, ammonium methyl dodecylbenzene sulfonate, ammonium dodecylbenzene sulfonate, sodium octadecylbenzene sulfonate, sodium nonylbenzene sulfonate, sodium dodecylnaphthalene sulfonate, sodium hetadecylbenzene sulfonate, potassium eicososyl naphthalene sulfonate, ethylamine undecylnaphthalene sulfonate, sodium docosylnaphthalene sulfonate, sodium octadecyl sulfate, sodium hexadecyl sulfate, sodium dodecyl sulfate, sodium nonyl sulfate, ammonium decyl sulfate, potassium tetradecyl sulfate, diethanolamino octyl sulfate, triethanolamine octadecyl sulfate, amrnmonium nonyl sulfate, ammonium nonylphenoxyl tetraethylenoxy sulfate, sodium dodecylphenoxy triethyleneoxy sulfate, ethanolamine decylphenoxy tetraethyleneoxy sulfate, or potassium octylphenoxy triethyleneoxy sulfate.

Examples of nonionic surfactants include, but are not limited to, the condensation product between ethylene oxide or propylene oxide with the propylene glycol, ethylene diamine, diethylene glycol, dodecyl phenol, nonyl phenol, tetradecyl alcohol, N-octadecyl diethanolamide, N-dodecyl monoethanolamide, polyoxyethylene sorbitan monooleate, or polyoxyethylene sorbitan monolaurate.

Examples of cationic surfactants include, but are not limited to, ethyl-dimethylstearyl ammonium chloride, benzyl-dimethyl-stearyl ammonium chloride, benzyldimethyl-stearyl ammonium chloride, trimethyl stearyl ammonium chloride, trimethylcetyl ammonium bromide, dimethylethyl dilaurylammonium chloride, dimethyl-propyl-myristyl ammonium chloride, or the corresponding methosulfate or acetate.

The coating composition is a water-based composition. The composition can be prepared using techniques known in the art. For example, the base soluble polymer, volatile base, surfactant, and water can be added in any order followed by admixing the components to produce a solution or dispersion. It is contemplated that other organic solvents can be added. The solvent is preferably one that can be readily removed during the drying step. It is also contemplated that other components can be present in the coating composition. For example, the coating composition further comprises a wax. Examples of waxes useful herein include, but are not limited to, carnauba wax, beeswax, paraffin wax, microcrystalline wax, polyethylene wax, polypropylene wax, a fatty acid amide, or a polytetrafluoroethylene. In one aspect, the coating composition is Michem® Prime 4983R, 4990R, and MP 2690 manufactured by Michelman Specialty Chemistry, which is a dispersion of polyethylene-acrylic acid in ammonia water.

Application of Coating Composition

The coating composition can be applied to the surface of the LCD glass using techniques known in the art. For example, the coating composition can be applied to the glass by spraying, dipping, meniscus coating, flood coating, rollers, brushes, etc. In one aspect, the coating composition is applied by spraying since it readily accommodates movement of the glass introduced by the glass manufacturing process. In one aspect, both sides of the glass can be sprayed simultaneously, although sequential coating of individual sides can be performed if desired.

The temperature of the glass upon coating can vary. In one aspect, the glass has a temperature of from 25° C. to 300° C. In another aspect, the coating composition can be applied to a newly formed sheet of glass immediately after the forming process. For example, the coating composition can be applied to the glass while its temperature is above 175° C., above 200° C., or above 250° C., where the temperature of the glass is preferably measured with an infrared detector of the type commonly used in the art. Application of the coating composition at this point in the manufacturing process is advantageous because the glass is clean, and the film produced by the coating composition will protect the glass during the remainder of the manufacturing process. Application of a film to glass at this temperature means that the application time may need to be relatively short depending on the rate at which the glass is being formed and the minimum glass temperature permitted at the end of the application process.

The glass can be formed by several different processes, including float processes, slot-draw processes, and fusion draw processes. See, for example, U.S. Pat. Nos. 3,338,696 and 3,682,609, which are incorporated herein by reference in their entirety. In the slot-draw and fusion draw processes, the newly-formed glass sheet is oriented in a vertical direction. In such cases, the coating composition can be applied under conditions that do not result in the formation of drips since such drips can interfere with cutting of the glass, e.g., the drips can cause the glass to crack. In general terms, dripping can be avoided by careful adjustment of coating flows coupled with application at glass temperatures above 150° C. As flow of coating is adjusted, the glass temperature and glass speed are held constant so that uniform coatings across a surface are achieved.

In certain aspects, the glass surface may need cleaning prior to application of the coating composition. This cleaning can be accomplished by various means including chemical cleaning methods known in the art and pyrolysis. The objective of these methods is to expose the hydroxyl groups and siloxane bonds from molecules in the glass. The following cleaning techniques can be used to remove absorbed organic molecules from the glass surface. In one aspect, the glass can be cleaned with an aqueous detergent such as, for example, SemiClean KG. In another aspect, UV/ozone cleaning can be used to clean the glass. UV/ozone cleaning is carried out with a low pressure mercury lamp in an atmosphere containing oxygen. This is described, for example, in Vig et al., J. Vac. Sci. Technol. A 3, 1027, (1985), the contents of which are incorporated herein by reference. A low pressure mercury grid lamp from BHK (88-9102-20) mounted in a steel enclosure filled with air is suitable for carrying out this cleaning method. The surface to be cleaned may be placed about 2 cm from the lamp, which may be activated for about 30 minutes, after which the surface is clean.

After the glass has been coated with the coating composition, the coated glass is dried to remove the water and volatile base to produce a protective film on the surface of the glass. The drying step can be performed by applying heat to the coated glass using techniques known in the art, and will vary depending upon, amongst other things, the volatile base used. In one aspect, the drying step comprises evaporation at room temperature. Alternatively, the coated glass can be cured after the film is applied. A curing step may enhance the hydrophobicity of the films. The curing may be accomplished by any means, such by forming free radicals via exposure to ionizing radiation, plasma treatment, or exposure to ultraviolet radiation at levels sufficient to achieve curing but not so high as to degrade the desired coating properties or remove the coating. In one aspect, the drying step results in removing enough volatile base so that the base soluble polymer is not solubilized by the aqueous volatile base.

After the drying step, a film is produced on the surface of the glass. The thickness of the film will vary depending upon the amount of coating composition that is applied to the glass. In one aspect, film has a thickness of from 1 μm to 15 μm, 1 μm to 13 μm, 1 μm to 11 μm, 1 μm to 9 μm, 1 μm to 7 μm, or 1 μm to 5 μm.

The glass can be rinsed after the film material has been applied after the drying step. In one aspect, rinsing can be done with sonication to improve film removal. This rinsing can remove the bulk of the excess film material. The coated glass can be cut into any desired shape. Cutting and/or grinding of glass sheets typically involves the application of water to the sheet. This water can perform the rinsing of the coating to remove excess film material.

Removal of the Film

The coating compositions described herein can be applied to the glass before it is scored for the first time and are robust enough to survive the rest of the manufacturing process. The protective film can be removed by using various commercial detergent packages either alone or in combination with brush washing and/or ultrasonic cleaning. The detergent packages can optionally contain both an anionic surfactant and a nonionic surfactant. Alternatively, the detergent can be an alkaline detergent. In one aspect, the detergent is an aqueous detergent such as, for example, SemiClean KG detergent. In another aspect, the protective film can be removed by a base. Examples of bases useful herein include NH₄OH, KOH, etc. The concentration of base used will vary depending upon the content and thickness of the protective film.

After the removal of the protective film, the surface of the glass is very clean. For example, after removal of the protective film, the glass has a particle density increase of less than 50 particles/cm², of less than 40 particles/cm², less than 30 particles/cm², less than 20 particles/cm², less than 10 particles/cm², or less than 5 particles/cm². The number of particles on the glass surface can be measured using a dark and/or bright field strobe light device that has a sensitivity down to 0.5 micron diameter particles. In another aspect, after the removal of the protective film, the glass has a contact angle of less than 20 degrees, less than 18 degrees, less than 16 degrees, less than 14 degrees, less than 12 degrees, less than 10 degrees, or less than 8 degrees as measured by water drop with a goniometer. In a further aspect, after the removal of the protective film, the glass has a roughness of from 0.15 to 0.6 nm. In another aspect, the glass has a roughness of from 0.15, 0.2, 0.25, 0.3, 0.35, 0.4, 0.45, 0.5, 0.55, or 0.6 nm, where any value can form a lower and upper endpoint of a roughness range.

It should be noted that the removal of the coating can be done by the manufacturer of the glass or the glass can be shipped to the ultimate user, e.g., a manufacturer of liquid crystal display devices, and the user can remove the coating from the glass.

In summary, coating compositions and methods described herein have numerous advantages. The coating compositions are environmentally-safe and can be applied to hot glass produced from the glass manufacturing process. Further, the coating compositions and methods protect glass sheets from ambient contaminants that the glass can be exposed to during, for example, storage or transportation. Another advantage is the reduction of chip adhesions when a glass sheet is cut or ground. As discussed above, glass chip adhesions present a significant problem in the manufacture of cut or ground glass, particularly in the manufacture of LCD glass. In particular, the methods described herein reduce the formation of chip adhesions by providing a stable removable coating on the surface of the glass sheet.

The coating compositions described herein such as, for example, MP 2960, also do not stick to interleaf paper. For example, LCD glass can be stored and shipped in stacks of sheets of glass. Between each sheet of glass, a piece of interleaf paper is used to further protect the glass. The coatings described herein do not stick to the interleaf paper at simulated dense pack stack/aging conditions (85% relative humidity, 50° C. for 16 hours, weighted to 27 g/cm²).

A further advantage of the methods is that the surface of the glass sheet after removal of the coating has substantially the same chemistry and smoothness as it had prior to application of the coating. Furthermore, the protective film can be removed using a variety of detergents and/or bases.

### EXAMPLES

The following examples are put forth so as to provide those of ordinary skill in the art with a complete disclosure and description of how the materials, articles, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Materials

The coating composition was obtained from Michelman Specialty Chemistry, Inc. (Cincinnati, Ohio) under their code MP-4983R-PL and MP 2960. Either coating is soluble in ammonia or high pH after drying. The coatings can be mixed in any proportion. It provides a thin, micron range, semi-transparent coating that will resist dirt, wear, water and other elements. It dries at room temperature to form a clear film. It is a consumer product, and not considered hazardous.

The majority of the experiments involved coating precleaned 5″ square glass specimens, then washing the coating off with subsequent surface measurement of the specimens. The glass specimens were measured using a dark and/or bright field strobe light device that has sensitivity down to 0.5 to 1 micron diameter particles on the surface. When the glass samples had a particle density of 5 particles/cm² or less, they were acceptable for further coating and testing. After coating removal, a sample was considered “clean” if the particle density increase (difference of initial vs. final) is 10 particles/cm² or less.

Removability of the Coating

Table 1 shows that the coating can be washed off after dipping various coating thicknesses using the SemiClean KG detergent, currently used in washing lines in Asia. The detergent concentration was 4%, the temperature was 71° C., and the time was 15 minutes. Table 1 also shows that the coating thickness increases from 0.03 microns for a 1.2% solution to about 12 microns for a 24% solution. The neat solution, supplied by the vendor is 12%. A contact angle of less than 8 degrees after the coating was removed from the glass surfaces was also observed, further indicating clean surfaces were obtained. Table 2 shows that 250° C. glass surfaces can be coated and effectively cleaned.

TABLE 1

| | Drying | Coating | | |
|---|---|---|---|---|
| Concentration | Conditions | Thickness | Gain in Particle Density | |
| Wt % | (° C./Min) | Microns | Average | Std Dev |
| 0.24 | Ambient | — | 2.5 | 1.4 |
| 1.2 | 70/15 | 0.03 | 0.3 | 1.3 |
| 24 | 80 C./15 | 8-10 | 4.1 | 1.7 |
| 24 | 100/10 | 10-14 | 3.4 | 0.8 |

Table 2 demonstrates that 250° C. glass surfaces can be coated and effectively cleaned.

TABLE 2

| n in | Coating | Detergent | Detergent | Glass | Particle d | Std |
|---|---|---|---|---|---|---|
| set | % | % | Temp | Temp | increase | Dev |
| 10 | 24% | 4% | 71° C. | 250° C. | 5.71 | 7.36 |
| 8 | 24% | 4% | 71° C. | 250° C. | 9.50 | 12.87 |
| 10 | 6% | 4% | 71° C. | 250° C. | 0.30 | 1.80 |

Protection During Edge Finishing Operations

Table 3 shows coating protection during edge finishing. Acceptable particle density gain results are less than 10.

TABLE 3

| Con- | | | | | |
|---|---|---|---|---|---|
| cen- | | | | | |
| tra- | Drying | Coating | | Gain in Particle | |
| tion | Conditions | Thickness | Chuck | Density | |
| Wt % | (C./Min) | Microns | Material | Average | Std Dev |
| 0.24 | Ambient | — | Rodel | 54.6 | 9.7 |
| | | | O-Ring | 34.0 | 24.4 |
| 1.2 | 70/15 | 0.03 | O-Ring | 2.0 | 2.4 |
| | | | O-Ring | 133.8 | 29.4 |
| | | | O-Ring | 16.0 | 6.6 |
| | | | Rodel | 224.4 | 12.6 |
| 24 | 100/10 | 10-14 | Rodel | 1.7 | 1.4 |
| | | | Rodel | 5.3 | 2.1 |

Further testing was completed using the anticipated range of coatings and it was found that the 6% to 12% range protected during edge grinding, as displayed in Table 4.

TABLE 4

| Acrylic Concentration | Particle Density | Approx thickness |
|---|---|---|
| 1.20% | 11.96 | 0.2 |
| 6% | 1.53 | 2 |
| 24% | 1.94 | 15 |

Coating Removal Without Detergent

The interest in removal without detergent is high since customers in Asia are required to install detergent reclamation systems. Table 5 shows that washing with 0.1N KOH (pH=12) successfully removes the coating. The outliers (40, 26) are likely due to a water spot issue, observed on one glass sheet, and not a result of coating adherence.

TABLE 5
KOH washing
24% Acrylic Coating

40
−0.59
0.06
26.82
−0.19
−1.91
0.07
−0.11
−0.31
0.2

Dense Pack Applicability

Glass sheets are generally shipped almost in contact with each other or separated only by paper interleaf sheets, in dense pack containers. This package style is required instead of current polypropylene cases with separation slots due to size and weight (=high shipment cost), as well as sag issues of larger generation glass.

Testing was performed by weighting a stack of 10 coated glass specimens with 27.4 g/cm², as well as storing overnight in a humidity chamber at 50 c and 85% RH, to simulate dense pack shipment conditions. Again the glass used is pre-cleaned, and the resultant particle density gain is considered good if the result is less than 10. Table 6 shows dense pack simulation results. The first row shows a 12% coating that was not separated with interleaf paper, and subsequently blocked together after the humidity/temperature aging. The second row with a 12% coating employed the interleaf paper, but relatively high results were obtained. The third row involved a thinner coating, using a 6% solution, and higher washing concentration and temperature. Here the results are dramatically better, as best as can be measured by this technique. For comparison the last row contains the 2 sided Visqueen results. The coating provides results equivalent if not better than Visqueen.

TABLE 6

| | | | Aging | | |
|---|---|---|---|---|---|
| | | | Time @ | | |
| | | | 50° C., | | |
| | | | 85% rh | Interleaf | Results, |
| Coating | Wash | Wash | 18 | Paper | Particles/cm², |
| % | conc. | Temp. | degree | Used? | STDEV |
| 24 | 2% | 45° C. | 16 hr | NO | Stuck |
| 24 | 2% | 45° C. | 16 hr | NSP-50 | 16.8, 9.0 |
| 12 | 4% | 65° C. | 16 hr | NSP-50 | 0.1, 0.63 |
| 2-sided | 2% | 45° C. | 16 hr | NSP-50 | 2.45, 0.93 |
| Visqueen | | | | | |

Scoring Through the Coating

An initial investigation into scoring through the coating was completed, and the results are shown in Table 7. The ability to score and separate glass that was coated with even 12% concentrations was demonstrated.

TABLE 7

| | | Score | Score Depth | |
|---|---|---|---|---|
| Concentration | Score pressure | ID | (m) | Comments |
| 24% | 0.03 | 6 | 18 | Some vent loss |
| | | 8 | 16 | |
| | 0.05 | 3 | 38 | |
| | | 7 | 41 | |
| | 0.07 | 2 | 51 | large vent loss |
| | | 6 | 56 | |
| | 0.1 | 3 | 64 | |
| | | 7 | 68 | |
| | 0.12 | 1 | 78 | |
| | | 6 | 91 | |
| 12% | 0.03 | 3 | 27 | some vent loss |
| | | 7 | 28 | |
| | 0.05 | 3 | 42 | |
| | | 7 | 41 | |
| | 0.07 | 2 | 63 | |
| | | 6 | 69 | |
| | 0.1 | 3 | ** | complete vent |
| | | | | loss |
| | | 7 | 78 | vent loss at 2^{nd} |
| | | | | half of edge |
| | 0.12 | 3 | 85 | |
| | | 7 | 89 | |

Coating Applicability to Hot Glass Surfaces

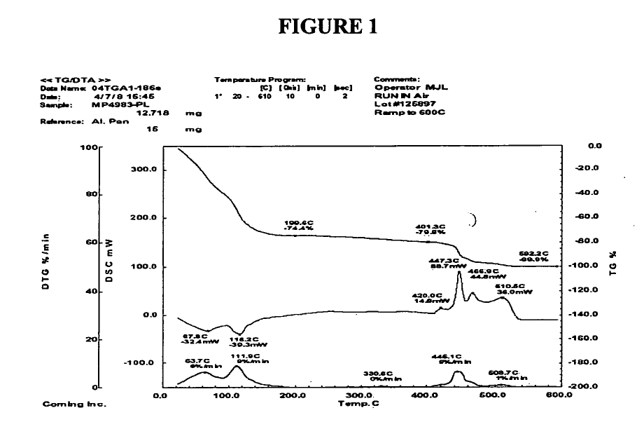

The thermal analysis data of the acrylic coating is shown in FIG. 1. It was observed that the coating does not decompose below 400° C. The coating loses water by 200° C. This data shows that hot BOD application (temperatures up to 300° C.) is certainly possible, and that the coating can be easily dried without competing reactions. Further thermal analysis traces (not shown) provided time/temp curves for optimal oven drying well below 200° C.

Coating Effects on the Glass Surface after Removal

Many surface analytical techniques, as well as chemical techniques have been used to examine the potential of the acrylic coating to influence the glass surface. In each case, it has been verified that the effect is not significant.

Glass Surface Roughness

Table 8 shows the effect on surface roughness measured by atomic force microscopy after removal of the coating. A slight increase in roughness vs. the control glass was observed; however this is within the range of Gateway treatment results, and also within the range of some normal glass measurements (e.g., the 0.3 range).

TABLE 8

| Sample ID | Ra | Rms |
|---|---|---|
| Control | 0.220 | 0.277 |
| Control | 0.215 | 0.272 |
| 12% | 0.244 | 0.308 |
| 12% | 0.250 | 0.315 |
| 24% | 0.247 | 0.311 |
| 24% | 0.246 | 0.311 |

The XRF data is shown in Table 9. It was observed that there were essentially no differences in the glass composition between the 2000F with the coating removed, and the 2000F from the production date on or near the coated glass production date. The only differences were in the antimony oxide, and tin oxide levels between the standard glass produced in a different time period vs. the glass produced the date of production. This difference is likely attributable to a glass tank to tank variation.

TABLE 9

| | Al₂O₃ | As₂O₃ | BaO | CaO | Fe₂O₃ | Na₂O | Sb₂O₃ | SiO₂ | SnO₂ | SrO |
|---|---|---|---|---|---|---|---|---|---|---|
| Sample name | (%) | (%) | (%) | (%) | (%) | (%) | (%) | (%) | (%) | (%) |
| 745BHC Standard | 16.30 | 1.04 | 0.056 | 7.86 | 0.022 | 0.038 | 0.021 | 63.20 | 0.073 | 0.76 |
| J90 115010-1 2000 F COATING | 16.35 | 1.057 | 0.036 | 7.88 | 0.014 | 0.031 | 0.016 | 63.39 | 0.131 | 0.78 |
| REMOVED | | | | | | | | | | |
| Glass at production date | 16.34 | 1.056 | 0.031 | 7.82 | 0.014 | 0.037 | 0.015 | 63.43 | 0.117 | 0.79 |

X-Ray Photoelectron Spectroscopy (XPS or ESCA)

Data from XPS surface analysis (Table 10) clearly showed that the surface of a control sample and the surface of a glass that is coated, then washed, were indistinguishable. Data further indicated that the surface of a coated sample consisted primarily of carbon, oxygen and silicon. There was some concern that a surface silicon-like (Si—O bonds) compound may be present. No such compound was found on the glass, or on the underside of the coating applied to the glass, however. Table 10 shows the XPS data in atomic % for the 12% 4983R coated sample, the coated-washed sample, and the control.

TABLE 10

| Sample | B | C | N | O | Al | Si | Ca | Sr |
|---|---|---|---|---|---|---|---|---|
| Control, area 1 | 2.5 | 9.4 | 0.4 | 60.8 | 4.0 | 21.5 | 1.2 | 0.1 |
| Control, area 2 | 2.8 | 8.9 | 0.3 | 60.9 | 4.1 | 21.7 | 1.3 | 0.1 |
| Average | 2.6 | 9.2 | 0.4 | 60.8 | 4.0 | 21.6 | 1.3 | 0.1 |
| Coated-Washed, area 1 | 3.0 | 10.1 | 0.4 | 59.5 | 4.0 | 21.7 | 1.3 | 0.1 |
| Coated-Washed, area 2 | 2.7 | 9.2 | 0.3 | 61.2 | 4.0 | 21.3 | 1.2 | 0.1 |
| Average | 2.9 | 9.6 | 0.3 | 60.3 | 4.0 | 21.5 | 1.2 | 0.1 |
| 24% Coated, area 1 | — | 93.4 | — | 5.1 | — | 1.6 | — | — |
| 24% Coated, area 2 | — | 93.3 | — | 5.4 | — | 1.4 | — | — |
| Average | — | 93.3 | — | 5.2 | — | 1.5 | — | — |

Time of Flight Secondary Ion Mass Spectrometry (TOF-SIMS)

The TOF-SIMS data (Table 11) showed only the top monolayers of material, and was able to identify surface organic functional groups characteristic of coating material. This data again showed the coated/washed sample was not distinguishable from the uncoated control sample. The coated and peeled coating sample provides some evidence of silicone-type materials on the surface, not present under the coating or on the glass. It is worth noting that the Na⁺ content of the coated/washed glass was very close to the control when compared to the coated/peeled glass. It is desirable to reduce the Na⁺ content in LCD glass, as the Na⁺ ions can adversely affect the performance of the glass.

TABLE 11

| | | | | | Coated/Peeled | |
|---|---|---|---|---|---|---|
| | Control | | Coated/Washed | | | Std. |
| Ion | Average | Std. Dev. | Average | Std. Dev. | Average | Dev. |
| B+ | 84.5 | 1.9 | 102.6 | 15.1 | 69.0 | 6.3 |
| Na+ | 6.0 | 0.1 | 9.1 | 4.6 | 1769.9 | 46.7 |
| Mg+ | 6.5 | 0.1 | 8.1 | 1.5 | 7.4 | 0.8 |
| Al+ | 1247.0 | 9.0 | 1446.1 | 248.0 | 1325.2 | 175.9 |
| Si+ | 2298.7 | 9.6 | 2789.5 | 407.5 | 2198.2 | 257.9 |
| K+ | 48.3 | 1.9 | 58.4 | 20.2 | 181.2 | 38.2 |
| Ca+ | 421.6 | 2.5 | 370.3 | 63.7 | 112.2 | 12.2 |
| Sr+ | 23.9 | 1.4 | 31.4 | 5.1 | 5.2 | 0.7 |
| C₂H₃+ | 184.8 | 7.1 | 207.3 | 56.0 | 210.9 | 45.9 |
| SiOH+ | 414.5 | 7.3 | 464.5 | 76.3 | 278.7 | 57.7 |
| C₂H₅O+ | 32.1 | 4.5 | 14.5 | 6.9 | 10.0 | 2.7 |
| C₄H₇+ | 88.8 | 4.4 | 109.1 | 36.7 | 133.0 | 42.2 |
| C₃H₈N+ | 289.6 | 10.3 | 142.2 | 48.8 | 24.6 | 0.9 |
| C₃H₇O+ | 35.8 | 7.5 | 8.6 | 5.0 | 2.9 | 0.8 |
| C₈H₅O₃+ | 49.3 | 4.3 | 45.0 | 57.3 | 34.1 | 40.1 |

Nanoindentation

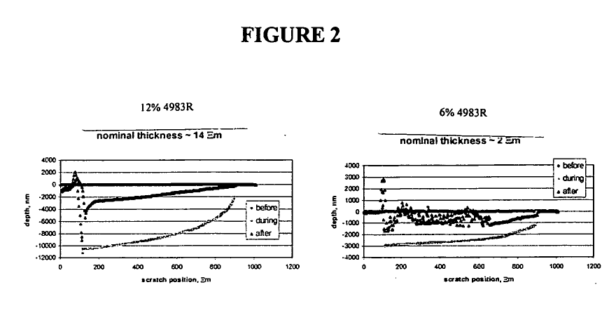

12% coatings and 24% coatings were examined to better understand the role of coating thickness in protection of the surface from scratches. The noise in the 12% data indicated the stylus had broken through the substrate and plowed the coating. The 24% coating was shown to be many times better for the same loads. As expected thicker coatings are more scratch resistant. FIG. 2 shows the nanoindentation data for the 12% coating (a thickness of 2 microns) and 24% coating (a thickness of 14 microns).

Glass Surface Chemical Durability after Coating Removal

Initial testing of durability after coating removal revealed that the quantitative acid durability in HCl was slightly poorer, although the visual rating of the surface was the same as the standard. Table 12 displays the (second round) results for HCl durability. The highlighted area in Table 12 shows the higher weight change observed for the once coated glasses, and also shows little difference between glasses coated at room temperature and glass surfaces held at 250° C. before coating. Results for other acids using previously coated samples were not distinguishable from standards (not shown).

This HCl durability measurement was repeated (third round), and the findings indicated that the glass surface durability after coating removal was not an issue, as shown in Table 13. In addition, the base glass was investigated for ammonia durability, since it was thought to be the “cause” of the problem noted in the original analysis. The ammonia data is highlighted in Table 13, so that it is not compared with the rest of the chart. If there were a problem, the ammonia numbers after just 6 hours are much too high to explain the issue originally noticed.

TABLE 12

| | | | | | WEIGHT | WEIGHT | WEIGHT | | |
|---|---|---|---|---|---|---|---|---|---|
| | | | TEMP | | CHANGE | CHANGE | CHANGE | APPEARANCE | |
| Glass | MEDIUM | CONC | Deg C. | TIME | mg | mg/cm2 | % w/w | CHANGE | NOTE |
| 2000 F. | HCl | 5% w/w | 95 | 24 hr | −15.4 | −0.576 | −0.812 | mod-h overall haze | Sample = |
| coated | HCl | 5% w/w | 95 | 24 hr | −14.05 | −0.525 | −0.735 | mod-h overall haze | Standard |
| @ RT | | | | | | | | | |
| 2000 F. | HCl | 5% w/w | 95 | 24 hr | −14.42 | −0.536 | −0.759 | mod-h overall haze | Sample = |
| coated | HCl | 5% w/w | 95 | 24 hr | −13.61 | −0.506 | −0.717 | mod-h overall haze | Standard |
| @ 250 C. | | | | | | | | | |
| 2000 F. | HCl | 5% w/w | 95 | 24 hr | −10.98 | −0.408 | −0.575 | mod-h overall haze | Sample = |
| uncoated | HCl | 5% w/w | 95 | 24 hr | −10.91 | −0.407 | −0.569 | mod-h overall haze | Standard |
| 2000 F. | HCl | 5% w/w | 95 | 24 hr | −11.31 | −0.421 | −0.540 | mod-h overall haze | Sample = |
| crate 86 | HCl | 5% w/w | 95 | 24 hr | −11.41 | −0.424 | −0.545 | mod-h overall haze | Standard |

TABLE 13

| | | | | | | WEIGHT | WEIGHT | | |
|---|---|---|---|---|---|---|---|---|---|
| | SPECIMEN | | | TEMP | | CHANGE | CHANGE | APPEARANCE | |
| Glass | ID | MEDIUM | CONC | deg C. | TIME | mg/cm2 | % w/w | CHANGE | NOTE |
| 2000 F. | R61 | HCl | 5% w/w | 95 | 24 hr | −0.438 | −0.616 | mod-h overall haze | Sample = |
| coated @ | R62 | HCl | 5% w/w | 95 | 24 hr | −0.505 | −0.709 | mod-h overall haze | Standard |
| RT | R63 | HCl | 5% w/w | 95 | 24 hr | −0.478 | −0.670 | mod-h overall haze | |
| 6 days | | | | | | | | | |
| 2000 F. | 12R1 | HCl | 5% w/w | 95 | 24 hr | −0.492 | −0.694 | mod-h overall haze | Sample = |
| coated | 12R2 | HCl | 5% w/w | 95 | 24 hr | −0.476 | −0.676 | mod-h overall haze | Standard |
| @ RT | 12R3 | HCl | 5% w/w | 95 | 24 hr | −0.446 | −0.630 | mod-h overall haze | |
| 12 days | | | | | | | | | |
| 2000 F. | 12H1 | HCl | 5% w/w | 95 | 24 hr | −0.468 | −0.653 | mod-h overall haze | Sample = |
| coated | 12H2 | HCl | 5% w/w | 95 | 24 hr | −0.460 | −0.650 | mod-h overall haze | Standard |
| @ 250 C. | 12H3 | HCl | 5% w/w | 95 | 24 hr | −0.494 | −0.689 | mod-h overall haze | |
| 12 days | | | | | | | | | |
| 2000 F. | UC1 | HCl | 5% w/w | 95 | 24 hr | −0.449 | −0.630 | mod-h overall haze | Sample = |
| uncoated | UC2 | HCl | 5% w/w | 95 | 24 hr | −0.432 | −0.609 | mod-h overall haze | Standard |
| sample | UC3 | HCl | 5% w/w | 95 | 24 hr | −0.452 | −0.636 | mod-h overall haze | |
| | UC4 | NH₄OH | 5% w/w | 95 | 6 hr | −0.153 | −0.216 | NC | Sample = |
| | UC5 | NH₄OH | 5% w/w | 95 | 6 hr | −0.160 | −0.225 | NC | Standard |
| 2000 F. | IS2 | HCl | 5% w/w | 95 | 24 hr | −0.405 | −0.525 | mod-h overall haze | |
| “std” | IS3 | NH₄OH | 5% w/w | 95 | 6 hr | −0.172 | −0.223 | NC | |
| crate 37 | IS4 | NH₄OH | 5% w/w | 95 | 6 hr | −0.148 | −0.192 | NC | |

Throughout this application, various publications are referenced. The disclosures of these publications in their entireties are hereby incorporated by reference into this application in order to more fully describe the compounds, compositions and methods described herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. A method for protecting glass for a liquid crystal display, comprising (i) applying to at least one surface of the glass a coating composition, wherein the coating composition comprises:
(a) a base soluble polymer;
(b) a volatile base;
(c) a surfactant; and
(d) water,
to produce a coated glass, and (ii) drying the coated glass to remove the water and volatile base to produce a protective film on the surface of the glass.

2. The method of claim 1, wherein the base soluble polymer comprises a polymer comprising at least one carboxylic acid group, sulfonate group, phosphonate group, phenolic group, or a combination thereof.

3. The method of claim 1, wherein the base soluble polymer comprises a polymer comprising at least one carboxylic acid group.

4. The method of claim 1, wherein the base soluble polymer comprises a polymer derived from an acrylic acid monomer.

5. The method of claim 1, wherein the base soluble polymer comprises a homopolymer derived from an acrylic acid monomer.

6. The method of claim 1, wherein the base soluble polymer comprises a copolymer derived from an acrylic acid monomer.

7. The method of claim 1, wherein the base soluble polymer comprises a polymerization product between an acrylic acid monomer and an olefin.

8. The method of claim 7, wherein the acrylic acid monomer comprises acrylic acid, methacrylic acid, or a mixture thereof.

9. The method of claim 7, wherein the olefin comprises ethylene, propylene, butylene, or a mixture thereof.

10. The method of claim 1, wherein the base soluble polymer comprises polyethylene acrylic acid copolymer.

11. The method of claim 1, wherein the volatile bases comprises a trialkyl amine or a hydroxyalkyl amine.

12. The method of claim 1, wherein the volatile bases comprises triethylamine or triethanolamine.

13. The method of claim 1, wherein the volatile base comprises ammonia.

14. The method of claim 1, wherein the surfactant comprises an anionic surfactant.

15. The method of claim 14, wherein the anionic surfactant comprises an alkyl aryl sulfonate, an alkyl sulfate, or sulfated oxyethylated alkyl phenol.

16. The method of claim 14, wherein the anionic surfactant comprises sodium dodecylbenzene sulfonate, sodium decylbenzene sulfonate, ammonium methyl dodecylbenzene sulfonate, ammonium dodecylbenzene sulfonate, sodium octadecylbenzene sulfonate, sodium nonylbenzene sulfonate, sodium dodecylnaphthalene sulfonate, sodium hetadecylbenzene sulfonate, potassium eicososyl naphthalene sulfonate, ethylamine undecylnaphthalene sulfonate, sodium docosylnaphthalene sulfonate, sodium octadecyl sulfate, sodium hexadecyl sulfate, sodium dodecyl sulfate, sodium nonyl sulfate, ammonium decyl sulfate, potassium tetradecyl sulfate, diethanolamino octyl sulfate, triethanolamine octadecyl sulfate, ammonium nonyl sulfate, ammonium nonylphenoxyl tetraethylenoxy sulfate, sodium dodecylphenoxy triethyleneoxy sulfate, ethanolamine decylphenoxy tetraethyleneoxy sulfate, or potassium octylphenoxy triethyleneoxy sulfate.

17. The method of claim 1, wherein the surfactant comprises a nonionic surfactant.

18. The method of claim 17, wherein the nonionic surfactant comprises the condensation product between ethylene oxide or propylene oxide with the propylene glycol, ethylene diamine, diethylene glycol, dodecyl phenol, nonyl phenol, tetradecyl alcohol, N-octadecyl diethanolamide, N-dodecyl monoethanolamide, polyoxyethylene sorbitan monooleate, or polyoxyethylene sorbitan monolaurate.

19. The method of claim 1, wherein the surfactant comprises a cationic surfactant.

20. The method of claim 19, wherein the cationic surfactant comprises ethyl-dimethylstearyl ammonium chloride, benzyl-dimethyl-stearyl ammonium chloride, benzyldimethyl-stearyl ammonium chloride, trimethyl stearyl ammonium chloride, trimethylcetyl ammonium bromide, dimethylethyl dilaurylammonium chloride, dimethyl-propyl-myristyl ammonium chloride, or the corresponding methosulfate or acetate.

21. The method of claim 1, wherein the coating composition further comprises a wax.

22. The method of claim 21, wherein the wax comprises carnauba wax, beeswax, paraffin wax, microcrystalline wax, polyethylene wax, polypropylene wax, a fatty acid amide, or a polytetrafluoroethylene.

23. The method of claim 1, wherein during step (i) the glass has a temperature of from 25° C. to 300° C.

24. The method of claim 1, wherein after drying step (ii), the coating has a thickness of from 1 μm to 15 μm.

25. The method of claim 1, wherein drying step (ii) comprises evaporation at room temperature.

26. The method of claim 1, wherein drying step (ii) comprises heating the coated glass.

27. The method of claim 1, wherein the coating composition is applied to the glass by spraying, dipping, meniscus coating, flood coating, rolling, or brushing.

28. The method of claim 1, wherein the coating composition comprises polyethylene acrylic acid, ammonia, and water.

29. The method of claim 1, wherein after drying step (ii), cutting the glass into a desired shape.

30. The method of claim 29, further comprising grinding and/or polishing at least one edge of the cut glass.

31. The method of claim 1, wherein after step (ii) the protective film can be removed by contacting the film with a base, a detergent, or a mixture thereof.

32. The method of claim 31, wherein after the removal of the protective film, the glass has a particle density increase of less than 50 particles/cm².

33. The method of claim 31, wherein after the removal of the protective film, the glass has a particle density increase of less than 10 particles/cm².

34. The method of claim 31, wherein after the removal of the protective film, the glass has a particle density increase of less than 5 particles/cm².

35. The method of claim 31, wherein after the removal of the protective film, the glass has a contact angle of less than 20 degrees as measured by water drop with a goniometer.

36. The method of claim 31, wherein after the removal of the protective film, the glass has a contact angle of less than 8 degrees as measured by water drop with a goniometer.

37. The method of claim 31, wherein after the removal of the protective film, the glass has a roughness of from 0.15 nm to 0.6 nm.

38. A glass for liquid crystal display comprising a protective film on at least one surface of the glass, wherein the protective film comprises a base soluble polymer and a surfactant.
